(19) United States
(12) Patent Application Publication
(10) Pub. No.: US 2003/0146046 A1
(43) Pub. Date: Aug. 7, 2003

(54) Convertible ladder

(76) Inventor: Dennis Simpson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/147,115

(22) Filed: May 16, 2002

Related U.S. Application Data
(60) Provisional application No. 60/355,026, filed on Feb. 7, 2002.

(51) Int. Cl. E06C 1/00

(52) U.S. Cl. 182/23; 182/163

(57) ABSTRACT

A convertible ladder including a first ladder portion, a second ladder portion and a static hinge mechanism. The first ladder portion has a first locking mechanism proximate a first end thereof. The second ladder portion has a second locking mechanism proximate a first end thereof. The static hinge mechanism is attached to the first ladder portion with the first locking mechanism. The static hinge mechanism is attached to the second ladder portion with the second locking mechanism. The static hinge mechanism maintains the first ladder portion in a stationary relation with respect to the second ladder portion.

### REFERENCE TO RELATED APPLICATION

The application claims the benefit of U.S. Provisional Application No. 60/355,026, filed Feb. 7, 2002, the disclosure of which is hereby incorporated by reference.

### FIELD OF THE INVENTION

The present invention relates generally to a ladder. More particularly, the present invention relates to a convertible ladder.

### BACKGROUND OF THE INVENTION

For some time it has been known that constructing ladders with two sections that are slidably mounted with respect to each other enables the overall length of the extension ladder to be varied depending upon the desired use of the extension ladder. This feature is particularly useful for transporting the ladder to a desired use location.

It is also known to construct ladders with two sections that are pivotally mounted together. Using this type of ladder enables the ladder to be used in locations where it is not possible to lean the ladder against a support structure such as a wall.

### SUMMARY OF THE INVENTION

The present invention is a convertible ladder that includes a first ladder portion, a second ladder portion and a static hinge. The static hinge is attachable to the first ladder portion and the second ladder portion to maintain the first ladder portion in a stationary position with respect to the second ladder portion.

### BRIEF DESCRIPTION OF THE DRAWINGS

FIG. 1 is a photograph of a convertible ladder according to the present invention.

FIG. 2 is a side view of a fixed hinge mechanism for use with the convertible ladder.

FIG. 3 is a top view of the fixed hinge mechanism.

FIG. 4 is a side view of the fixed hinge mechanism.

### DETAILED DESCRIPTION OF THE PREFERRED EMBODIMENTS

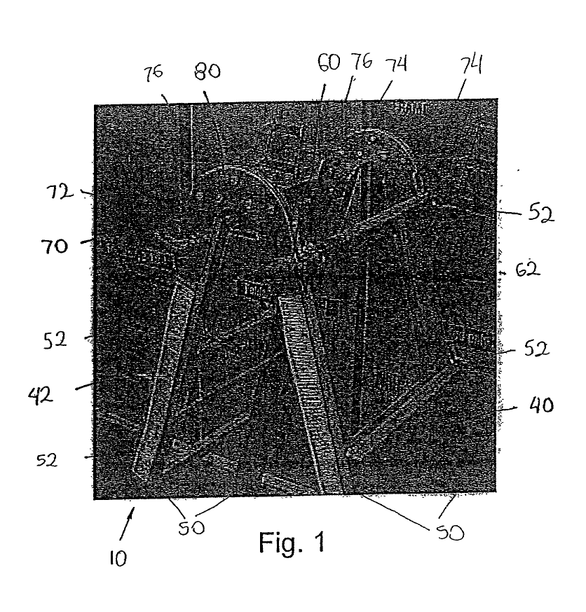

The present invention is a convertible ladder, as most clearly illustrated at 10 in FIG. 1. The convertible ladder 110 includes a first ladder portion 40, a second ladder portion 42 and a static hinge mechanism 80.

The first ladder portion 40 and the second ladder portion 42 each include a pair of side rails 50 and a plurality of rungs 52 that are mounted to extend between the side rails 50 at selected intervals. The side rails 50 preferably have a C-shaped configuration with a main section and a pair of leg sections that extend from the main section. A person of ordinary skill in the art will appreciate that the size of the side rails 50 and the rungs 52 is selected based upon the intended use of the convertible ladder.

The first ladder portion 40 and the second ladder portion 42 are preferably fabricated from a lightweight aluminum material. However, a person of ordinary skill in the art will appreciate that it is possible to fabricate the first ladder portion 40 and the second ladder portion 42 from alternate materials such as steel and fiberglass using the concepts of the present invention.

The first ladder portion 40 and the second ladder portion 42 have a pair of first locking mechanisms 60 and a pair of second locking mechanisms 70, respectively. The first locking mechanisms 60 are attached to the first and second legs 50 of the first ladder portion 40 proximate a first end 74 thereof. Similarly, the second locking mechanisms 70 are attached to the first and second legs 50 of the second ladder portion 42 proximate a first end 76 thereof.

Only one of the pair of first locking mechanisms 60 and the pair of second locking mechanisms 70 is illustrated in FIG. 1 because of the orientation of the convertible ladder 10. However, the convertible ladder 10 preferably has a symmetrical configuration where each of the first locking mechanisms 60 and the second locking mechanisms 70 are shaped substantially identical. The first locking mechanisms 60 and the second locking mechanisms 70 enable the static hinge mechanism 80 to be attached to the first ladder portion 40 and the second ladder portion 42.

The first locking mechanism 60 preferably includes a first handle 62 that is operably attached to the first ladder portion 40. The first handle 62 is movable between in an engaged position and an unengaged position. The first handle 62 is preferably biased to the engaged position. When in the engaged position, the first handle 62 engages the static hinge mechanism 80 and thereby maintains the first ladder portion 40 in a fixed position with respect to the static hinge mechanism 80. When in the disengaged position, the first handle 62 permits the first ladder portion 40 to be separated from the static hinge mechanism 80.

Similar to the first locking mechanism 60, the second locking mechanism 70 preferably includes a second handle 72 that is operably attached to the second ladder portion 42. The second handle 72 is movable between in an engaged position and an unengaged position. The second handle 72 is preferably biased to the engaged position. When in the engaged position, the second handle 72 engages the static hinge mechanism 80 and thereby maintains the second ladder portion 42 in a fixed position with respect to the static hinge mechanism 80. When in the disengaged position, the second handle 72 permits the second ladder portion 42 to be separated from the static hinge mechanism 80.

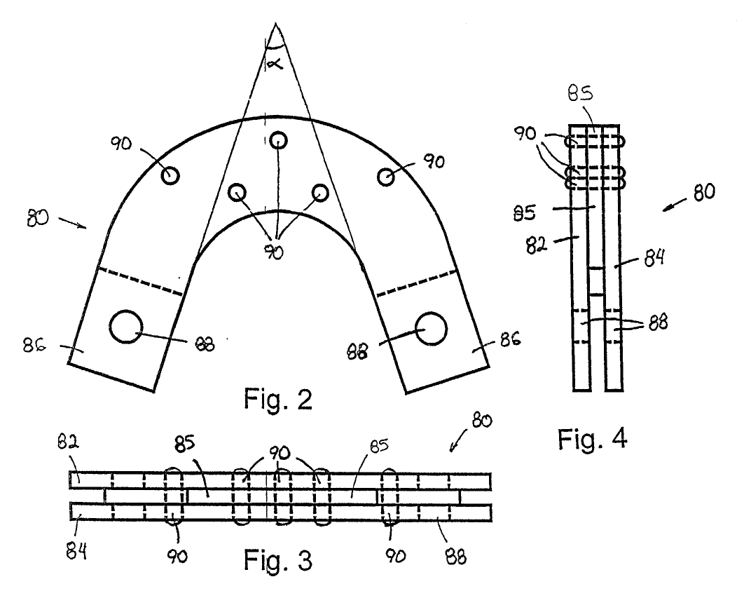

The structure of the fixed hinge mechanism 80 is most clearly illustrated in FIGS. 2-4. The fixed hinge mechanism 80 includes a first plate 82 and a second plate 84 that are attached together in a spaced-apart configuration.

The first plate 82 and the second plate 84 each preferably have a generally U-shaped configuration. An angle α between hinge legs 86 is less than 90 degrees, preferably between 20 and 50 degrees and most preferably about 35 degrees. A person of ordinary skill in the art will appreciate that the angle α is selected based upon the desired use conditions such as the weight that is to be placed on the first and second ladder portions 40, 42.

A length of the hinge legs 86 is selected so that the hinge legs 86 extend sufficiently into the first ladder portion 40 and the second ladder portion 42 to prevent the first ladder portion 40 and the second ladder portion 42 from rotating with respect to each other, as illustrated in FIG. 1.

Proximate the end of the hinge legs 86, each of the hinge legs 86 has an aperture 88 formed therein. The aperture 88 is adapted to receive either the first handle 62 or the second handle 72 to thereby retain the fixed hinge mechanism 80 in a fixed position with respect to the first ladder portion 40 and the second ladder portion 42.

Positioned between the first plate 82 and the second plate 84 is an intermediate plate 85. The intermediate plate 85 maintains the first plate 82 and the second plate 84 in a spaced apart relationship. The intermediate plate 85 also limits the extent to which the first ladder portion 40 and the second ladder portion 42 can be inserted into the fixed hinge mechanism 80.

The first plate 82, the second plate 84 and the intermediate plate 85 are attached to each other with a plurality of reinforcing members 90. The number and size of the reinforcing members 90 is selected based upon the anticipated load that is to be placed on the convertible ladder 10. A spacer is also provided to maintain the first plate 82 and the second plate 84 at a desired position with respect to each other. A stop is further provided on the fixed hinge mechanism 80 to limit a distance that the fixed hinge mechanism 80 may be inserted into the first side 40 and the second side 42.

The static hinge mechanism 80 is preferably fabricated from a lightweight aluminum material. However, a person of ordinary skill in the art will appreciate that it is possible to fabricate the static hinge mechanism 80 from alternate materials such as steel and fiberglass using the concepts of the present invention.

When the first ladder portion 40 is detached from the second ladder portion 42, it is possible to use these items separately. It is also possible to configure the first ladder portion 40 and the second ladder portion 42 so that the first ladder portion 40 is slidably mounted with respect to the second ladder portion 42 similar to a conventional extension ladder.

In this configuration, the second ladder portion 42 preferably includes a plurality of apertures (not shown) that extend through the side rails 50. The first handle 62 extends into the apertures to maintain the first ladder portion 40 in a fixed position with respect to the second ladder portion 42.

In operation, the convertible ladder 10 is initially in the first configuration where the first ladder portion 40 is attached to the second ladder portion 42 with the static hinge mechanism 80, as illustrated in FIG. 1.

Moving the first and second locking mechanisms 60, 70 from the engaged position to the disengaged position enables the first ladder portion 40 and the second ladder portion 42 to be separated from the static hinge mechanism 80 by sliding the first ladder portion 40 and the second ladder portion 42 away from the static hinge mechanism 80.

It is contemplated that features disclosed in this application, as well as those described in the above applications incorporated by reference, can be mixed and matched to suit particular circumstances. Various other modifications and changes will be apparent to those of ordinary skill.

1. A convertible ladder comprising:
a first ladder portion having a first locking mechanism proximate a first end thereof;
a second ladder portion having a second locking mechanism proximate a first end thereof; and
a static hinge mechanism, wherein the static hinge mechanism is attached to the first ladder portion with the first locking mechanism proximate the first end of the first ladder portion, wherein the static hinge mechanism is attached to the second ladder portion with the second locking mechanism proximate the first end of the second ladder portion, and wherein the static hinge mechanism maintains the first ladder portion in a stationary relation with respect to the second ladder portion.

2. The convertible ladder of claim 1, wherein the static hinge mechanism is U-shaped and has a pair of hinge legs.

3. The convertible ladder of claim 2, wherein an angle between the hinge legs is between 20 and 50 degrees.

4. The convertible ladder of claim 1, wherein the static hinge mechanism has a first plate, a second plate and an intermediate plate mounted between the first plate and the second plate.

5. The convertible ladder of claim 4, wherein a recess is defined between the first plate and the second plate, and wherein the intermediate plate limits a distance that the first ladder portion and the second ladder portion are extendable into the recess.

6. The convertible ladder of claim 4, wherein at least one of the first plate and the second plate has an aperture formed therein that is adapted to receive a portion of the first locking mechanism or the second locking mechanism.

7. The convertible ladder of claim 1, wherein the first and second locking mechanisms are movable between an engaged position and a disengaged position.

8. The convertible ladder of claim 7, wherein the first and second locking mechanisms are biased to the engaged position.

9. The convertible ladder of claim 1, wherein the first ladder portion and the second ladder portion each have a first side rail, a second side rail and a plurality of rungs that extend between the pair of first and second side rails.

10. The convertible ladder of claim 9, wherein the static hinge mechanism comprises a first static hinge portion and a second static hinge portion, wherein the first static hinge portion releasably attaches the first side rails on the first and second ladder portions, and wherein the second static hinge portion releasably attaches the second side rails on the first and second ladder portions.

11. The convertible ladder of claim 9, wherein the first and second side rails each have a C-shape with a main section and a pair of side sections that extend from the main section to define a recess therein, and wherein the recess is adapted to receive a portion of the static hinge mechanism.

12. The convertible ladder of claim 1, wherein the first ladder portion is slidably attachable to the second ladder portion using the first locking mechanism.

13. A convertible ladder comprising:
a first ladder portion having a first end;
a second ladder portion having a first end;
a static hinge mechanism;
a first locking mechanism for releasably attaching the static hinge mechanism to the first ladder portion, wherein the first locking mechanism engages the first ladder portion proximate the first end; and
a second locking mechanism for releasably attaching the static hinge mechanism to the second ladder portion, wherein the second locking mechanism engages the second ladder portion proximate the first end, wherein the static hinge mechanism maintains the first ladder portion in a stationary relation with respect to the second ladder portion.

14. The convertible ladder of claim 13, wherein the static hinge mechanism is U-shaped and has a pair of hinge legs.

15. The convertible ladder of claim 14, wherein an angle between the hinge legs is between 20 and 50 degrees.

16. The convertible ladder of claim 13, wherein the static hinge mechanism has a first plate, a second plate and an intermediate plate mounted between the first plate and the second plate.

17. The convertible ladder of claim 16, wherein a recess is defined between the first plate and the second plate, and wherein the intermediate plate limits a distance that the first ladder portion and the second ladder portion are extendable into the recess.

18. The convertible ladder of claim 16, wherein at least one of the first plate and the second plate has an aperture formed therein that is adapted to receive a portion of the first locking mechanism or the second locking mechanism.

19. The convertible ladder of claim 13, wherein the first and second locking mechanisms are movable between an engaged position and a disengaged position.

20. The convertible ladder of claim 19, wherein the first and second locking mechanisms are biased to the engaged position.

21. The convertible ladder of claim 13, wherein the first ladder portion and the second ladder portion each have a first side rail, a second side rail and a plurality of rungs that extend between the pair of first and second side rails.

22. The convertible ladder of claim 21, wherein the static hinge mechanism comprises a first static hinge portion and a second static hinge portion, wherein the first static hinge portion releasably attaches the first side rails on the first and second ladder portions, and wherein the second static hinge portion releasably attaches the second side rails on the first and second ladder portions.

23. The convertible ladder of claim 21, wherein the first and second side rails each have a C-shape with a main section and a pair of side sections that extend from the main section to define a recess therein, and wherein the recess is adapted to receive a portion of the static hinge mechanism.

24. The convertible ladder of claim 13, wherein the first ladder portion is slidably attachable to the second ladder portion using the first locking mechanism.

25. A convertible ladder comprising:
a first ladder portion having a first side rail, a second side rail, and a plurality of rungs that extend between the first side rail and the second side rail;
a second ladder portion having a first side rail, a second side rail, and a plurality of rungs that extend between the first side rail and the second side rail;
a first static hinge mechanism releasably attached to a first end of the first side rails on the first and second ladder portions; and
a second static hinge mechanism releasably attached to a first end of the second side rails on the first and second ladder portions, wherein the first and second static hinge mechanisms maintain the first ladder portion in a stationary relation with respect to the second ladder portion.

26. The convertible ladder of claim 25, wherein the first and second static hinge mechanisms each are U-shaped and have a pair of hinge legs.

27. The convertible ladder of claim 26, wherein an angle between the hinge legs is between 20 and 50 degrees.

28. The convertible ladder of claim 25, wherein the first and second static hinge mechanisms each have a first plate, a second plate and an intermediate plate mounted between the first plate and the second plate.

29. The convertible ladder of claim 28, wherein a recess is defined between the first plate and the second plate, and wherein the intermediate plate limits a distance that the first ladder portion and the second ladder portion are extendable into the recess.

30. The convertible ladder of claim 28, wherein at least one of the first plate and the second plate has an aperture formed therein that is adapted to receive a portion of the first locking mechanism or the second locking mechanism.

31. The convertible ladder of claim 25, wherein the first and second locking mechanisms are movable between an engaged position and a disengaged position.

32. The convertible ladder of claim 31, wherein the first and second locking mechanisms are biased to the engaged position.

33. The convertible ladder of claim 25, wherein the first and second side rails each have a C-shape with a main section and a pair of side sections that extend from the main section to define a recess therein, and wherein the recess is adapted to receive a portion of the static hinge mechanism.

34. The convertible ladder of claim 25, wherein the first ladder portion is slidably attachable to the second ladder portion using the first locking mechanism.
